(19) United States
(12) Patent Application Publication
(10) Pub. No.: US 2015/0151957 A1
(43) Pub. Date: Jun. 4, 2015

(54) WATER SERVER

(71) Applicant: Yoshinori Orita, Kakogawa (JP)

(72) Inventor: Yoshinori Orita, Kakogawa (JP)

(21) Appl. No.: 14/380,974

(22) PCT Filed: Jul. 4, 2012
(86) PCT No.: PCT/JP2012/067073

§ 371 Date: Aug. 26, 2014

(30) Foreign Application Priority Data
Mar. 2, 2012 (JP) 2012-046302

(51) Int. Cl. B67D 1/07; B67D 1/10; B67D 1/00; B67D 1/08

(52) U.S. Cl. CPC B67D 1/07; B67D 1/0857; B67D 1/10; B67D 1/0004; B67D 2001/075

(57) ABSTRACT

A hygienic water server is provided of which lines connected to a raw water container can be sterilized. The water server includes a cold water tank (2) in which drinking water is cooled. The cold water tank can be brought into communication with an exchangeable raw water container (4) through a raw water supply line (6) provided with a pump (7). Air can be introduced into the raw water container (4) through an air intake line (8) to which an ozone generator (9) is connected. The water server further includes a controller (35) adapted to activate the ozone generator (8) while the pump (7) is activated to generate ozone.

### TECHNICAL FIELD

This invention relates to a water server for supplying drinking water, such as mineral water, in an exchangeable raw water container.

### BACKGROUND ART

Water servers were used mainly in offices and hospitals. But with the recent growing interest in safety of water and health, a growing number of people are using water servers at homes too.

One such known water server includes a cold water tank in which drinking water is cooled, a raw water supply line through which an exchangeable raw water container is brought into communication with the cold water tank, and a pump provided at the raw water supply line (see e.g. the below-identified Patent documents 1 and 2).

Drinking water in the cold water tank of this water server can be discharged into a cup. When the water level in the cold water tank falls, the pump is activated to supply drinking water in the raw water container into the cold water tank. However, when water remaining in the raw water container decreases, it becomes difficult to draw drinking water in the raw water container due to a negative pressure generated in the raw water container. For this reason, it is in some cases impossible to completely use drinking water in the raw water container.

### PRIOR ART DOCUMENTS

### Patent Documents

Patent document 1: JP Patent Publication 2001-153523A
Patent document 2: JP Patent 4802299B

### SUMMARY OF THE INVENTION

### Object of the Invention

In order to make it possible to completely use drinking water in the raw water container, the inventor of the present invention provided the above-described type of water server, in which drinking water in the raw water container is drawn by a pump, with an air intake line through which air can be introduced into the raw water container. By providing such an air intake line, it became possible to prevent a negative pressure from being generated in the raw water container, irrespective of whether the raw water container is a rigid one which is not collapsible when water therein decreases, or is a flexible one which is collapsible when water therein decreases, and as a result, it became possible to completely use drinking water in the raw water container.

However, it was discovered that bacteria could proliferate in such air intake line when the water server is used over a long period of time because drinking water in the raw water tank partially flows into the air intake line. Bacteria could proliferate in the raw water supply line too, through which the raw water container communicates with the cold water tank.

An object of the present invention is to provide a hygienic water server of which the lines connected to the raw water container can be sterilized.

### Means for Achieving the Object

In order to achieve this object, the present invention provides a water server comprising a cold water tank in which drinking water is cooled, a raw water supply line through which an exchangeable raw water container is configured to be brought into communication with the cold water tank, a pump provided at the raw water supply line, an air intake line through which air can be introduced into the raw water container, an ozone generator connected to the air intake line, and a controller configured to activate the ozone generator such that the ozone generator generates ozone, while the pump is activated.

With this arrangement, when the pump is activated to draw drinking water in the raw water container, and as a result, air flows through the air intake passage into the raw water container due to reduced pressure in the raw water container, ozone generated by the ozone generator flows through the air intake line, sterilizing the interior of the air intake line. This prevents proliferation of bacteria in the air intake line, keeping the interior of the air intake line hygienic.

Preferably, the controller is configured to continuously activate the pump after the raw water container has run out of drinking water, thereby allowing ozone to flow through the air intake line and the raw water supply line.

With this arrangement, every time the exchangeable raw water tank becomes empty, ozone generated by the ozone generator flows through the air intake line and the raw water supply line, thus sterilizing the interiors of the air intake line and the raw water supply line. Both of the air intake line and the raw water supply line are therefore both kept hygienic after the water server has been used over a long period of time.

### Advantages of the Invention

In the water server according to the present invention, when the pump is activated and air flows into the raw water container through the air intake line, ozone generated in the ozone generator flows through the air intake line, thus sterilizing the interior of the air intake line. The water server is thus kept hygienic.

### BRIEF DESCRIPTION OF THE INVENTION

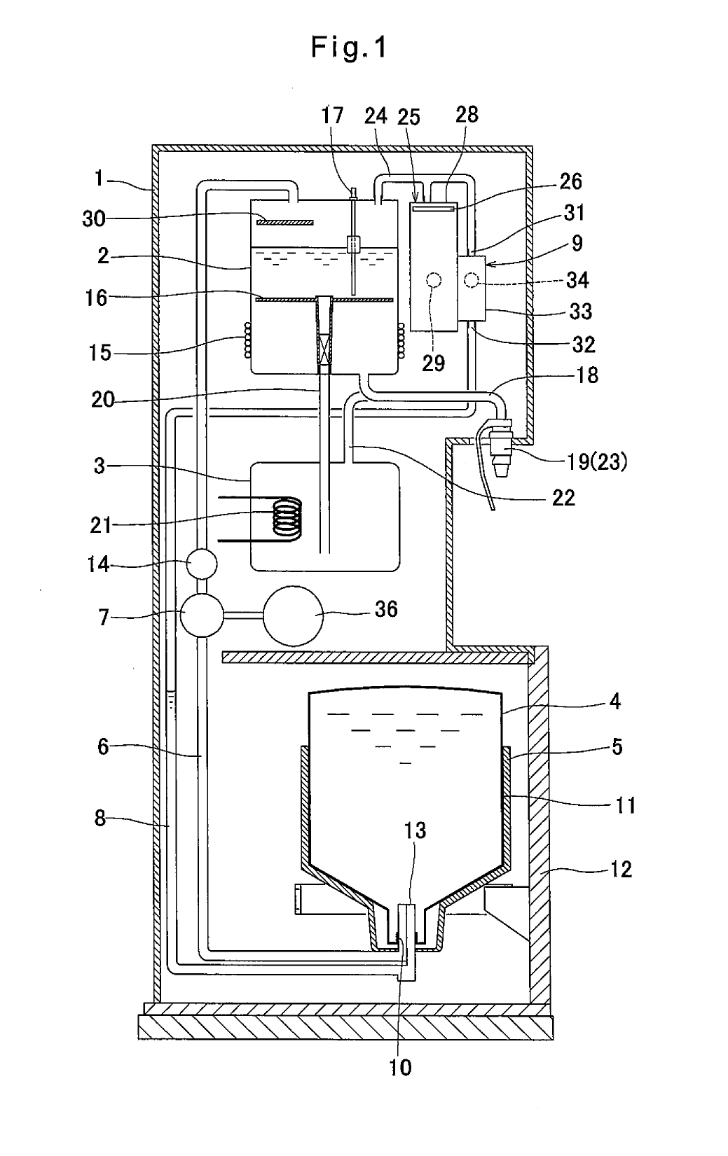

FIG. 1 is a sectional view of a water server embodying the present invention, in which the water server is seen from one side thereof.

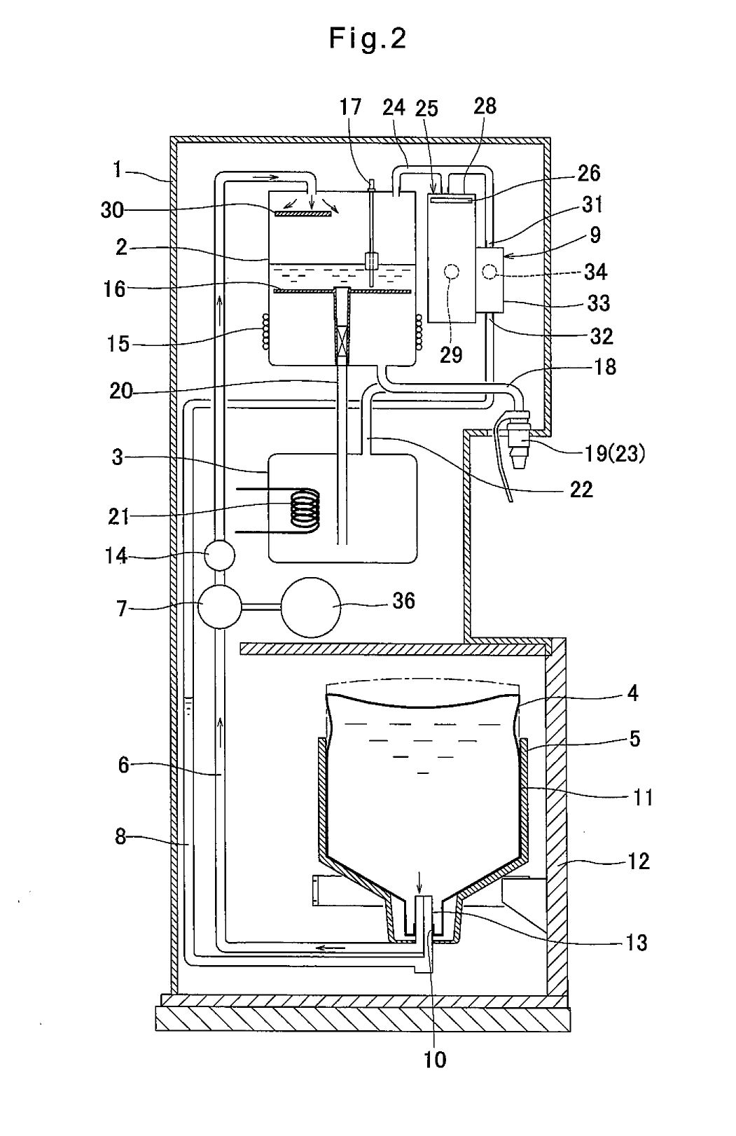

FIG. 2 shows a state of the water server of FIG. 1 in which drinking water in a raw water container is being drawn by a pump while a large amount of water still remains in the raw water container.

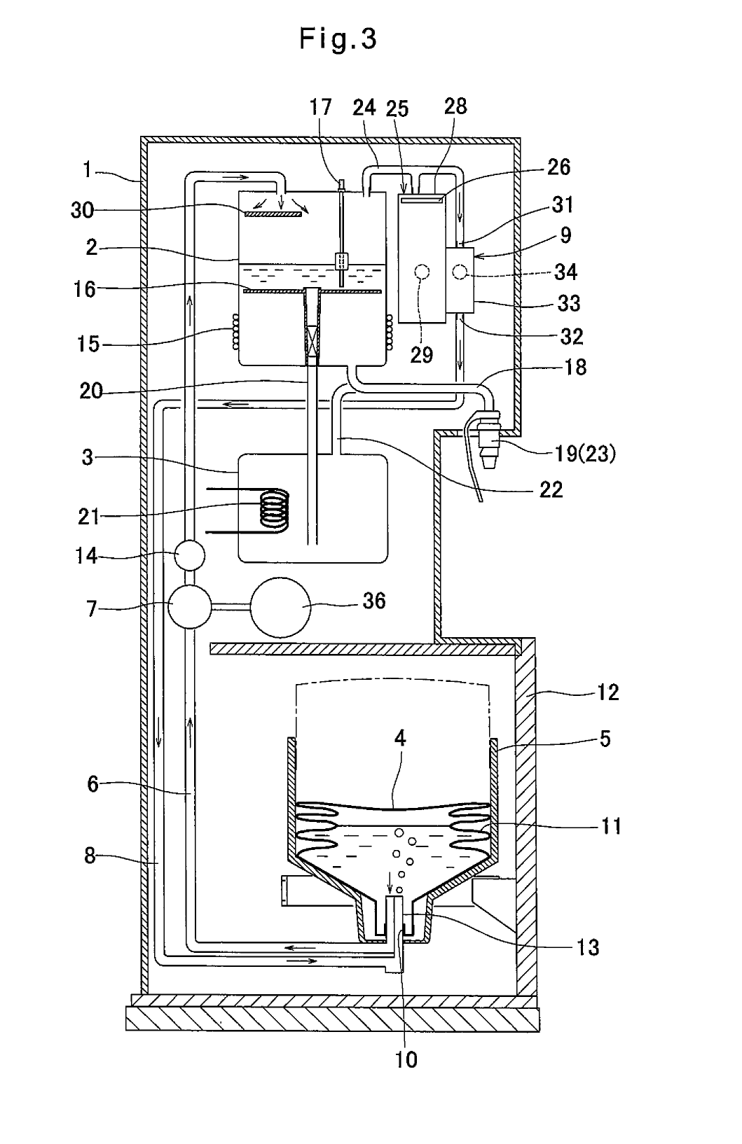

FIG. 3 shows a state of the water server of FIG. 1 in which drinking water in the raw water container is being drawn by the pump when water remaining in the raw water container has decreased.

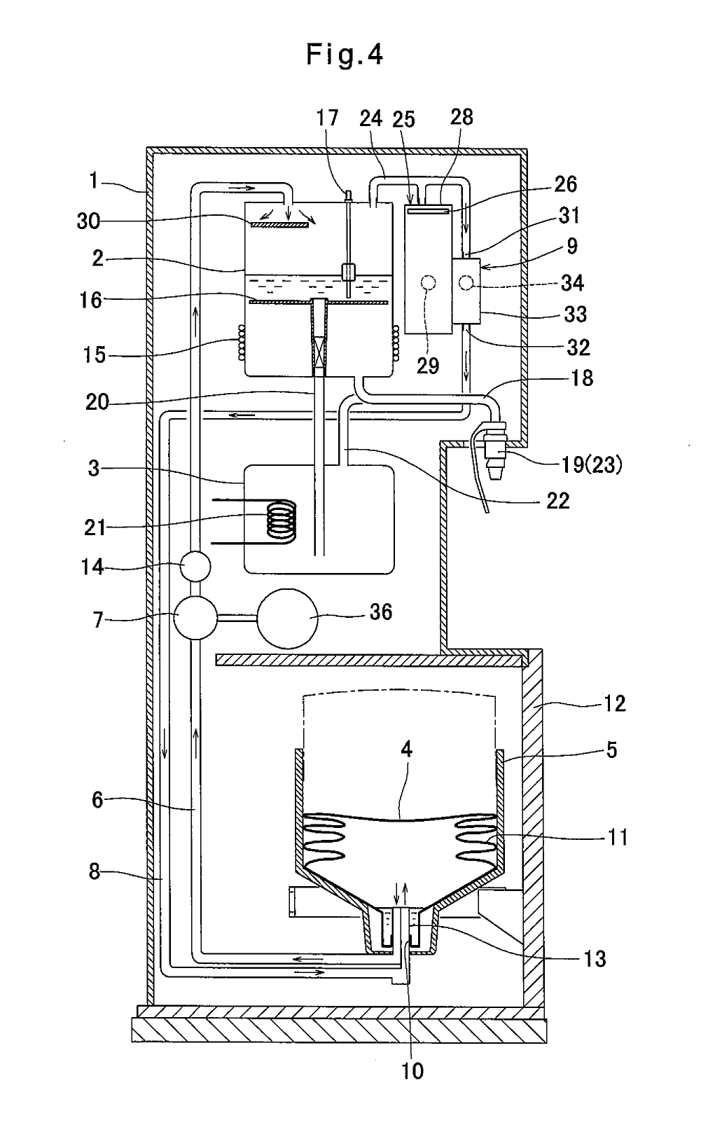

FIG. 4 shows a state of the water server of FIG. 1 in which the raw water container has run out of drinking water.

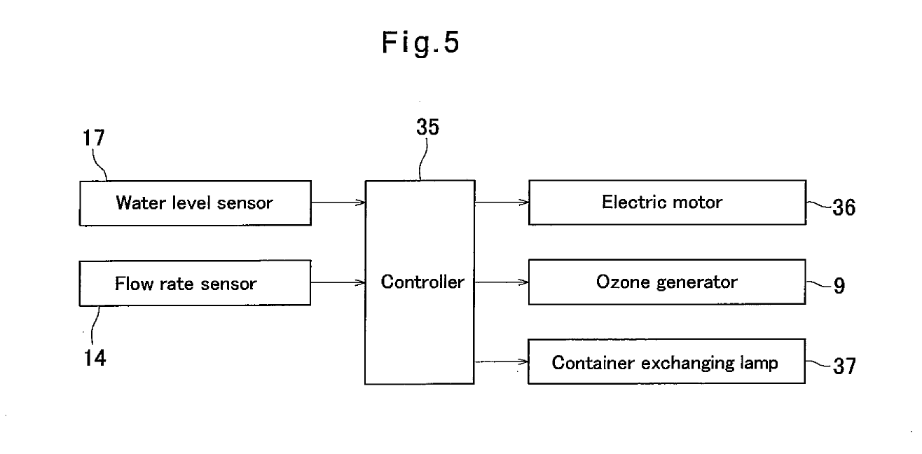

FIG. 5 is a block diagram of the water server shown in FIG. 1.

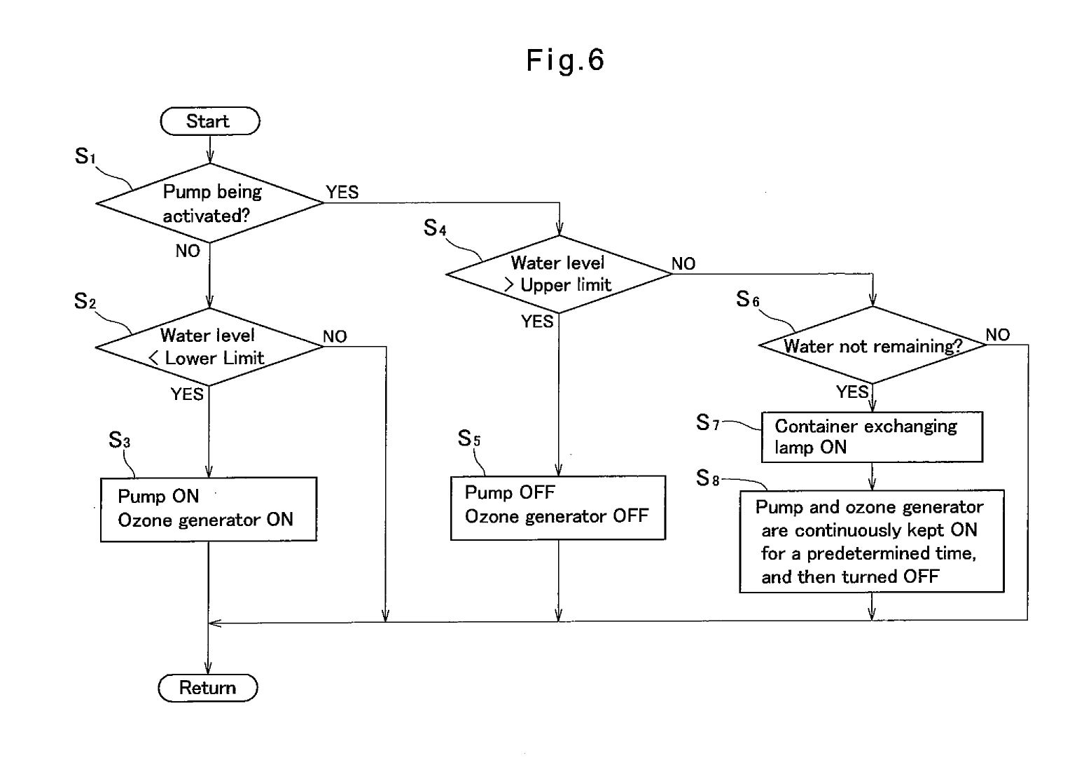

FIG. 6 shows a control flow of a controller shown in FIG. 5.

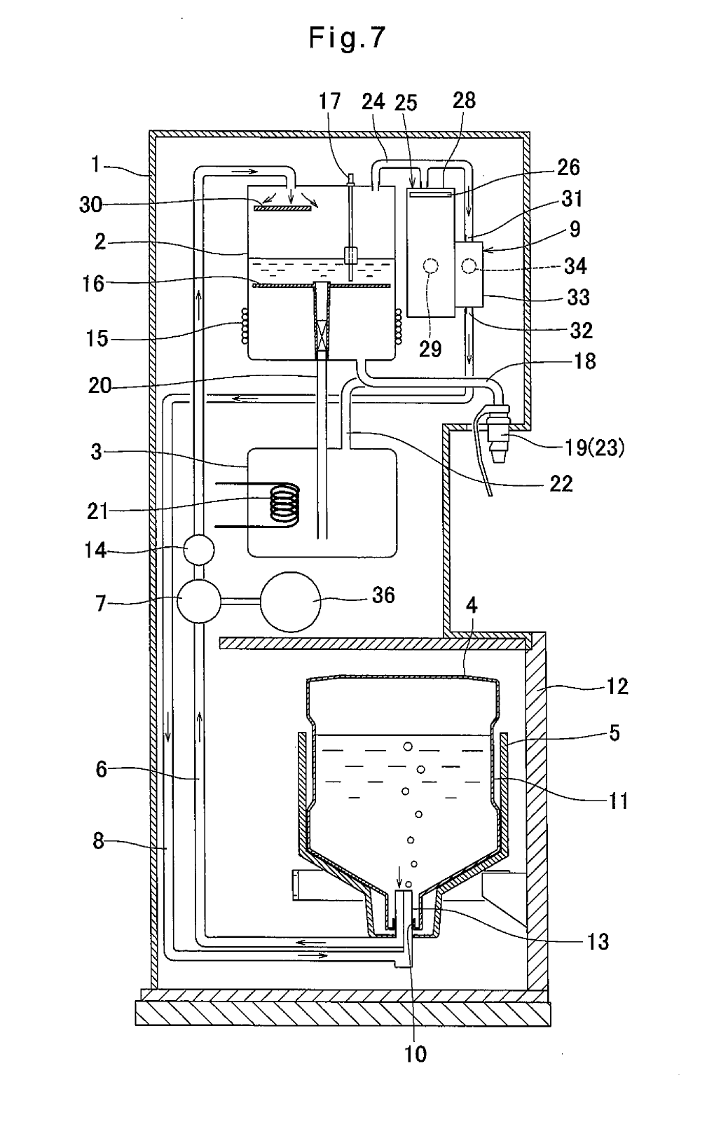

FIG. 7 shows a modified water server in which a rigid raw water container is used instead of the raw water container shown in FIG. 1.

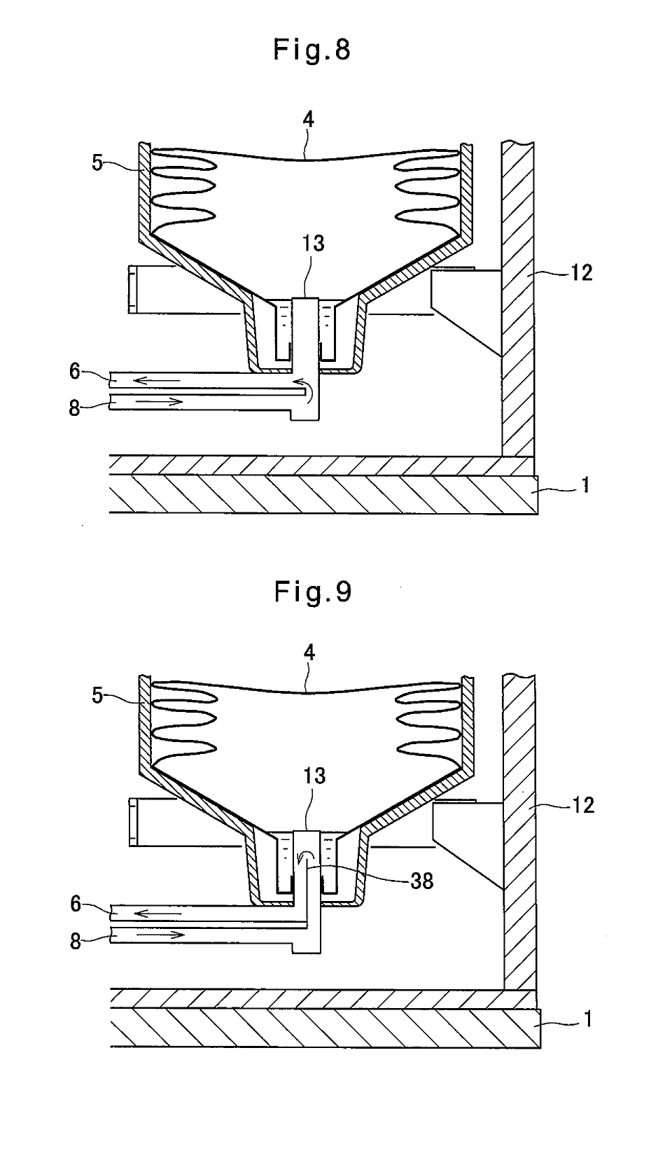

FIG. 8 is a sectional view showing a joint member as a modification of a joint member shown in FIG. 1.

FIG. 9 is a sectional view showing a joint member as another modification of the joint member of FIG. 1.

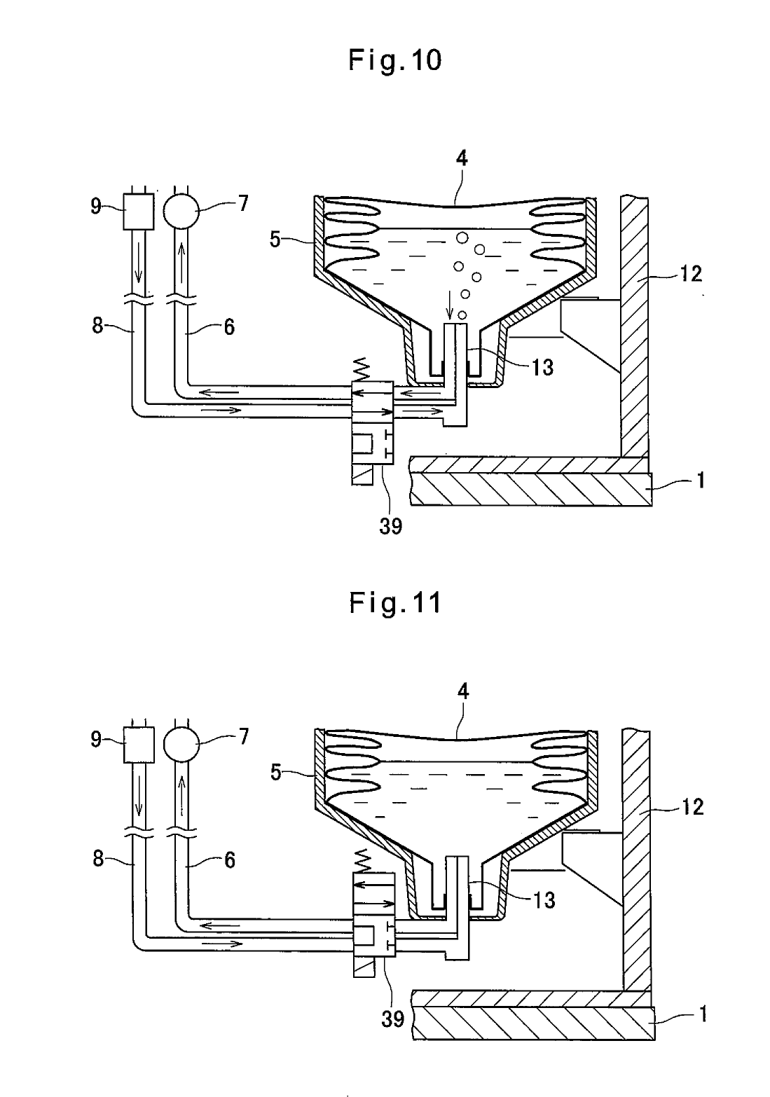

FIG. 10 shows a modified water server which differs from the water server shown in FIG. 1 in that the modified water server further includes a switching valve.

FIG. 11 shows the switching valve of FIG. 10 in a different position.

### BEST MODE FOR EMBODYING THE INVENTION

FIG. 1 shows a water server embodying the present invention. This water server includes a housing 1, and a cold water tank 2 and a warm water tank 3 both mounted in the housing 1. The water server further includes a container holder 5 in which an exchangeable raw water container 4 can be placed, and a raw water supply line 6 through which the raw water container 4 communicates with the cold water tank 2. A pump 7 is provided in the raw water supply line 6. The water server further includes an air intake line 8 through which air is introduced into the raw water container 4. An ozone generator 9 is connected to the air intake line 8.

The raw water container 4 is set in the container holder 5 with the water outlet 10 facing downward. The raw water container 4 has a trunk 11 which is flexible such that the raw water container 4 is collapsible as water remaining in the container 4 decreases. The raw water container 4 may e.g. be formed by blow-molding polyethylene terephthalate (PET) resin or polyethylene (PE) resin. The raw water container 4 has a capacity of about 8 to 20 liters.

In order that the raw water container 4 can be easily exchanged with a new one, the container holder 5 is mounted on a slide table 12 which is supported by the housing 1 so as to be slidable in a horizontal direction, such that the container holder 5 can be moved into and out of the housing 1. The container holder 5 is provided with a joint member 13 configured to be detachably connected to a water outlet 10 of the raw water container 4 when the raw water container 4 is set in the container holder 5. The joint member 13 is a vertically extending hollow tubular member. The raw water supply line 6 and the air intake line 8 have their respective ends near the raw water container 4 connected to the bottom end of the joint member 13.

The pump 7 and a flow rate sensor 14 are mounted to the raw water supply line 6 at their intermediate portions. The pump 7 is a gear pump including a pair of gears meshing with each other and adapted to feed drinking water by rotating the gears. When the pump 7 is activated, drinking water in the raw water supply line 6 is moved from the side of the raw water container 4 toward the cold water tank 2. Drinking water in the raw water container 4 can thus be supplied to the cold water tank 2. When the raw water supply line 6 runs out of drinking water, the pump 7 moves air in the raw water supply line 6 (which may be ozone-containing air) from the side of the raw water container 4 toward the cold water tank 2. When the raw water supply line 6 has run out of drinking water while the pump 7 is activated, the flow rate sensor 14 can detect this fact.

A cooling device 15 is mounted to the cold water tank 2 to cool drinking water in the cold water tank 2. A baffle plate 16 is mounted in the cold water tank 2 to divide the interior of the cold water tank 2 into upper and lower portions. The cooling device 15 surrounds the outer periphery of the lower portion of the cold water tank 2 and is configured to keep the portion of drinking water in the cold water tank 2 under the baffle plate 16 at a low temperature (about 5° C.).

A water level sensor 17 is mounted in the cold water tank 2 to detect the level of drinking water stored in the cold water tank 2. When the water level as detected by the water level sensor 17 falls to a predetermined level, the pump 7 is activated to supply drinking water into the cold water tank 2 from the raw water container 4. The baffle plate 16 prevents low-temperature drinking water that has been cooled by the cooling device 15 and collected at the lower portion of the cold water tank 2 from being stirred by normal-temperature water that has just been supplied from the raw water container 4 into the cold water tank 2.

A cold water discharge line 18 is connected to the cold water tank 2 through which low-temperature drinking water that has collected at the lower portion of the cold water tank 2 is discharged to the outside. The cold water discharge line 18 is provided with a cold water cock 19 which can be operated from outside the housing 1 so that by opening the cold water cock 19, low-temperature drinking water can be discharged into e.g. a cup. The capacity of the cold water tank 2 is smaller than that of the raw water container 4 and is about 2 to 4 liters.

The cold water tank 2 and the warm water tank 3 are connected together through a tank connecting line 20 of which the top end opens to the central portion of the baffle plate 16. A heating device 21 is mounted to the warm water tank 3 to heat drinking water in the warm water tank 3, thereby keeping the drinking water in the warm water tank 3 at a high temperature (about 90° C.). The tank connecting line 20 has a bottom open end located at a lower position than the heating device 21 in the warm water tank 3.

A warm water discharge line 22 is connected to the warm water tank 3 through which warm water that has collected at the upper portion of the warm water tank 3 is discharged to the outside. The warm water discharge line 22 is provided with a warm water cock 23 which can be operated from outside the housing 1 so that by opening the warm water cock 23, high-temperature drinking water can be discharged into e.g. a cup. When drinking water is discharged from the warm water tank 3, an equal amount of drinking water flows from the cold water tank 2 into the warm water tank 3 through the tank connecting line 20, so that the warm water tank 3 is always filled up with water. The warm water tank 3 has a capacity of about 1 to 2 liters.

An air sterilizing chamber 25 is connected to the cold water tank 2 through an air introducing line 24. The air sterilizing chamber 25 includes an ozone generating member 29 mounted in a hollow case 28 formed with an air intake port 26. The ozone generating member 29 may be a low-pressure mercury lamp, which converts oxygen in the air to ozone by ultraviolet radiation, or a silent discharge device, which is adapted to apply an alternating voltage between an opposed pair of electrodes covered with insulating members, thereby converting oxygen between the electrodes to ozone.

As the water level in the cold water tank 2 falls, a corresponding amount of air is introduced into the cold water tank through the air introducing line 24 to keep the interior of the cold water tank 2 at the atmospheric pressure. Since air introduced into the cold water tank 2 is sterilized by ozone in the air sterilizing chamber 25, air in the cold water tank 2 is kept clean.

A diffuser plate 30 is provided in the cold water tank 2 which diffuses the flow of drinking water from the raw water supply line 6 by the time it reaches the surface of drinking water already stored in the cold water tank 2. The diffuser plate 30 increases the surface area of drinking water supplied from the raw water supply line 6 that is brought into contact with ozone contained in the air in the cold water tank 2 (which has been introduced into the cold water tank 2 from the air sterilizing chamber 25), thus improving the hygiene of drinking water flowing into the cold water tank 2.

The air introducing line 24 has a branch connected to the ozone generator 9. The ozone generator 9 includes an ozone generating member 34 mounted in a hollow case 33 formed with an inlet 31 connected to the air introducing line 24, and an outlet 32 connected to the air intake line 8. As with the ozone generating member 29 of the air sterilizing chamber 25, the ozone generating member 34 may also be a low-pressure mercury lamp, which converts oxygen in the air to ozone by ultraviolet radiation, or a silent discharge device, which is adapted to apply an alternating voltage between an opposed pair of electrodes covered with insulating members, thereby converting oxygen between the electrodes to ozone.

In order to allow sliding movement of the slide table 12, which supports the container holder 5, and also to allow passage of ozone generated in the ozone generator 9 through the raw water supply line 6 and the air intake line 8, the raw water supply line 6 and the air intake line 8 are made of a material having flexibility and resistance to ozone. For example, the raw water supply line 6 and the air intake line 8 may be silicon tubes, fluororesin tubes or fluororubber tubes.

The pump 7 and the ozone generator 9 are controlled by a controller 35 shown in FIG. 5. The controller 35 receives a signal indicative of the level of drinking water stored in the cold water tank 2 from the water level sensor 17, and a signal indicative of the flow rate of drinking water in the raw water supply line 6 from the flow rate sensor 14. The controller 35 transmits a signal for controlling an electric motor for driving the pump 7, a control signal for controlling the ozone generator 9, and control signal for controlling a container exchanging lamp 37 which indicates the necessity of exchanging the raw water container. In particular, the lamp 37 indicates that the raw water container 4 has become empty, and is provided at the front side of the housing 1.

Now referring to FIGS. 6 and 2 to 4, it is described how the water server is controlled by the controller 35.

First, with the pump 7 not activated (Step S₁), when the water level sensor 17 detects that the water level in the cold water tank 2 has fallen below a predetermined lower limit (Step S₂), the pump 7 is activated to supply drinking water in the raw water container 4 into the cold water tank 2 (Step S₃). When the pump 7 is activated, the ozone generator 9 is also activated to generate ozone (Step S₃).

Next, with the pump 7 being activated (Step S₁), when the water level sensor 17 detects that the water level in the cold water tank 2 has exceeded a predetermined upper limit (Step S₄), the pump 7 is deactivated (Step S5). When the pump 7 is deactivated, the ozone generator 9 is also deactivated (Step S5). The ozone generator 9 may be deactivated simultaneously when the pump 7 is deactivated, or may be deactivated with a predetermined time delay after the pump 7 has been deactivated.

While a sufficiently large amount of drinking water remains in the raw water container 4 as shown in FIG. 2, when the pump 7 is activated to draw water in the raw water container 4 to supply water in the container 4 into the cold water tank 2, the raw water container 4 is gradually collapsed under the atmospheric pressure. Thus in this stage, no air flows into the raw water container 4 through the air intake line 8.

When water remaining in the raw water container 4 runs low as shown in FIG. 3, the raw water container 4 is already collapsed to such an extent that it is not collapsible any further due to increased rigidity. Thus, when the pump 7 is activated in this stage to draw water in the raw water container 4, pressure in the raw water container 4 decreases, so that air flows into the raw water container 4 through the air intake line 8. Since ozone is being generated from the ozone generator 9 in this state, the ozone flows through the air intake line 8 and the joint member 13 into the raw water container 4, thus sterilizing the interiors of the air intake line 8 and the joint member 13.

As shown in FIG. 6, with the pump 7 activated (Step S₁), when the flow rate sensor 14 detects that drinking water in the raw water supply line 6 runs out (Step S₆), the controller 35 determines that water in the raw water container 4 has run out, and turns on the container exchanging lamp 37 (Step S₇). After the flow rate sensor 14 has detected that drinking water in the raw water container 4 has run out, the controller 35 keeps the pump 7 and the ozone generator 9 activated for a predetermined period of time (Step S₈).

At this time, as shown in FIG. 4, ozone generated from the ozone generator 9 passes through the air intake line 8 and then the joint member 13, and flows into the lower portion of raw water container 4. Ozone that has flown into the lower portion of the raw water container 4 then passes through the joint member 13 and then the raw water supply line 6, and flows into the cold water tank 2. As a result, the interior of the air intake line 8, the interior of the joint member 13 and the interior of the raw water supply line 6 are sterilized by ozone.

In this water server, as described above, when the pump 7 is activated and as a result, air flows through the air intake line 8 into the raw water container 4, ozone generated from the ozone generator 9 flows through the air intake line 8, thus sterilizing the interior of the air intake line 8. The water server is thus kept hygienic.

In this water server, whenever water in every exchangeable raw water container 4 runs out, ozone generated in the ozone generator 9 flows through the air intake line 8 and the raw water supply line 6, thereby sterilizing the interiors of the air intake line 8 and the raw water supply line 6. This makes it possible to keep both the air intake line 8 and the raw water supply line 6 hygienic even after long use of the water server.

The raw water container 4 used in this embodiment is of the type that is collapsible as water in the container decreases. But this invention is applicable to a water server shown in FIG. 7, which uses a raw water container 4 not collapsible when water in the container 4 decreases. This raw water container 4 has a trunk 11 which is rigid enough that when water remaining in the raw water container 4 decreases, the raw water container 4 is not collapsible. In this embodiment, irrespective of the amount of water remaining in the raw water container, when the pump 7 is activated to draw drinking water in the raw water container 4, air flows into the raw water container 4 through the air intake line 8 due to a reduction in pressure in the raw water container 4. Since ozone is being generated in the ozone generator 9 in this state, the ozone flows through the air intake line 8 and then the joint member 13, and flows into the raw water container 4, thus sterilizing the interiors of the air intake line 8 and the joint member 13. This rigid raw water container 4 may e.g. be formed by blow-molding polyethylene terephthalate (PET) resin or polycarbonate (PC) resin.

Ozone generated in the ozone generator 9 is spontaneously decomposed into oxygen with time. Thus, when sterilizing the interiors of the raw water supply line 6 and the air intake line 8 with ozone, if it takes too long until ozone generated in the ozone generator 9 reaches the raw water supply line 6, the ozone concentration may decrease by the time ozone reaches the raw water supply line 6 to such an extent that the raw water supply line 6 cannot be sufficiently sterilized.

To avoid this problem, as shown in FIG. 8, the raw water supply line 6 and the air intake line 8 may be brought into communication with each other in the joint member 13. With this arrangement, ozone that has flown into the joint member 13 through the air intake line 8 flows into the raw water supply line 6 without flowing in the raw water container 4, so that ozone generated in the ozone generator 9 can reach the raw water supply line 6 in a shorter period of time, which makes it possible to more effectively sterilize the raw water supply line 6.

If the raw water supply line 6 and the air intake line 8 are brought into communication with each other in the joint member 13, as shown in FIG. 9, the raw water supply line 6 and the air intake line 8 may be partitioned from each other by a partition wall 38 extending vertically in the joint member 13 so that the raw water supply line 6 and the air intake line 8 communicate with each other through the space over the partition wall 38. With this arrangement, too, ozone that has flown into the joint member 13 through the air intake line 8 flows into the raw water supply line 6 without flowing in the raw water container 4, so that ozone generated in the ozone generator 9 can reach the raw water supply line 6 in a shorter period of time, which makes it possible to more effectively sterilize the raw water supply line 6. Further, when drinking water in the raw water container 4 flows into the raw water supply line 6, and simultaneously, air flows into the raw water container 4 through the air intake line 8, the arrangement of FIG. 9 prevents air in the air intake line 8 from being sucked into the raw water supply line 6 in the joint member 13. This makes it possible to more smoothly lift drinking water with the pump 7.

A switching valve 39 as shown in FIGS. 10 and 11 may be provided in the vicinity of the raw water container 4. The switching valve 39 can be moved between an open position (FIG. 10) and a closed position (FIG. 11). When the valve 39 is in the open position, the pump 7 and the raw water container 4 are in communication with each other through the raw water supply line 6, while the ozone generator 9 and the raw water container 4 are in communication with each other through the air intake line 8. When in the closed position, the valve 39 prevents communication between the pump 7 and the raw water container 4 through the raw water supply line 6 and also prevents communication between the ozone generator 9 and the raw water container 4 through the air intake line 8. However, in the closed position, the switching valve 39 is configured to allow communication between the portion of the raw water supply line 6 between the valve 39 and the pump 7 and the portion of the air intake line 8 between the valve 39 and the ozone generator 9. With this arrangement, with the switching valve 39 in the closed position, by activating the pump 7 and also activating the ozone generator 9 to generate ozone, it is possible to sterilize the air intake line 8 and the raw water supply line 6 even while drinking water is in the raw water container 4. Instead of the single switching valve 39 shown in FIGS. 10 and 11, a switching valve assembly 39 may be used which is a combination of a plurality of on-off valves and which is functionally identical to the valve 39 of FIGS. 10 and 11.

Measurement was made of the rate at which the concentration of ozone generated by the ozone generator 9 decreases as ozone flows through the air intake line 8. Measurement was made under the following conditions:

Air intake line: Silicon tube;

Inner diameter of the intake line: 4 mm;

Amount of air supplied by the pump: 1000 cc/minute; and

Ozone generating member: Quartz tube discharge lamp (single lamp or double lamps).

The measurement results indicate that the ozone concentration decreased as shown in Table 1 when a quartz tube discharge lamp (single lamp) was used as the ozone generating member 34.

TABLE 1

| Distance from ozone generator (m) | 0 | 1 | 2 | 3 |
|---|---|---|---|---|
| Ozone concentration (ppm) | 3 | 1.5 | 0.6 | 0.15 |
| Reduction rate (%) | 100 | 50 | 20 | 5 |

When quartz tube discharge lamps (double lamps) were used as the ozone generating members, the ozone concentration decreased as shown in Table 2.

TABLE 2

| Distance from ozone generator (m) | 0 | 1 | 2 | 3 |
|---|---|---|---|---|
| Ozone concentration (ppm) | 5.4 | 3.3 | 2.1 | 0.9 |
| Ozone concentration (ppm) | 6.6 | 4.1 | 2.7 | 1.2 |
| Average reduction rate (%) | 100 | 62 | 40 | 17 |

These measurement results indicate that the rate at which the ozone concentration decreases is lower when double lamps are used to generate ozone than when a single lamp is used. This in turn indicates that the higher the concentration of ozone generated by the ozone generator 9, the lower the rate at which the ozone concentration decreases. It was also discovered that when air containing ozone in the concentration of 5.5 ppm is fed from the ozone generator 9 into the air intake line 8, it was possible to effectively sterilize the air intake line 8 provided the air intake line 8 is three meters or shorter.

### DESCRIPTION OF THE NUMERALS

2. Cold water tank
4. Raw water container
6. Raw water supply line
7. Pump
8. Air intake line
9. Ozone generator
35. Controller

What is claimed is:

1. A water server comprising a cold water tank (2) in which drinking water is cooled, a raw water supply line (6) through which an exchangeable raw water container (4) is configured to be brought into communication with the cold water tank (2), a pump (7) provided at the raw water supply line (6), an air intake line (8) through which air can be introduced into the raw water container (4), an ozone generator (9) connected to the air intake line (8), and a controller (35) configured to activate the ozone generator (9) such that the ozone generator (9) generates ozone, while the pump (7) is activated.

2. The water server of claim 1, wherein the controller (35) is configured to continuously activate the pump (7) after the raw water container (4) has run out of drinking water, thereby allowing ozone to flow through the air intake line (8) and the raw water supply line (6).
